(19) United States
(12) Patent Application Publication
(10) Pub. No.: US 2021/0123411 A1
(43) Pub. Date: Apr. 29, 2021

(54) AN APPARATUS FOR CONVERTING WIND OR WATER ENERGY

(71) Applicant: Ferenc BEKO, Budapest (HU)

(72) Inventor: Ferenc BEKO, Budapest (HU)

(21) Appl. No.: 16/975,572

(22) PCT Filed: Jun. 11, 2019
(86) PCT No.: PCT/HU2019/000019

§ 371 Date: Aug. 25, 2020

(30) Foreign Application Priority Data
Jul. 17, 2018 (HU) P1800253

(51) Int. Cl. F03B 17/06; F03D 3/06; F03D 15/00

(52) U.S. Cl. CPC F03B 17/066; F03D 3/067; F05B 2260/4022; F05B 2260/30; F03D 15/00

(57) ABSTRACT

The subject-matter of the invention is an apparatus for converting energy of wind or water, it is driven by natural energy of wind or water, it is a rotating machine with either magnetic control or mechanic one where blades move along an open eccentric path with continuously changing radius in its construction; in the construction one or more sliding blocks (2) are fastened on a driven axle (1) shapes suitable for sliding are formed in the said blocks, their number depends on the number of blade arms (3) of the blades (5), there are secondary sliding blocks (4) and a power transmission system is established, which is realized by the driven axle (1) and the blades (5) led to a leading path (6) eccentric to the axle.

The subject-matter of the invention is a converter of wind or water energy driven by natural energy of wind or water, having magnetic control or provided with mechanic control of open eccentric path in a construction of a rotating energy converter with blades on a path of continuously changing radius where sliding blocks are fastened on the driven axle where one or more bodies depending on the number of arms of the blades are shaped enabling sliding including secondary sliding blocks mounted on the arms of the blades or on the blades and a system of connections built up from the said secondary sliding blocks is completed by the driven axle and blades led along an eccentric path in relation to the driven axle.

There are known technical structures with blades moving along eccentric paths in relation to the rotation centers of the driving axles wherein the paths of the blades are provided by closed technical solutions. The energy conversion in relation to the driving axle is performed always in the proportion of 1 to 1 in the known solutions. The essence of the construction according to the invention is that the utilized natural energy is always converted by the currently longest arms from among those having changing lengths during rotation. This fact moves extraordinarily to the foreground the small space requirement and highly efficient application of the construction according to the invention. It can be applied in rivers of small width and high speed or for secondary utilization of out flowing water of water-energy stations, in water-falls or for utilization of energy of moving mass of water of rivers. It can be also applied for utilization of wind energy both in small and large scales.

The proportion between the shortest and longest arms of moment is defined only by the status according to the state of art.

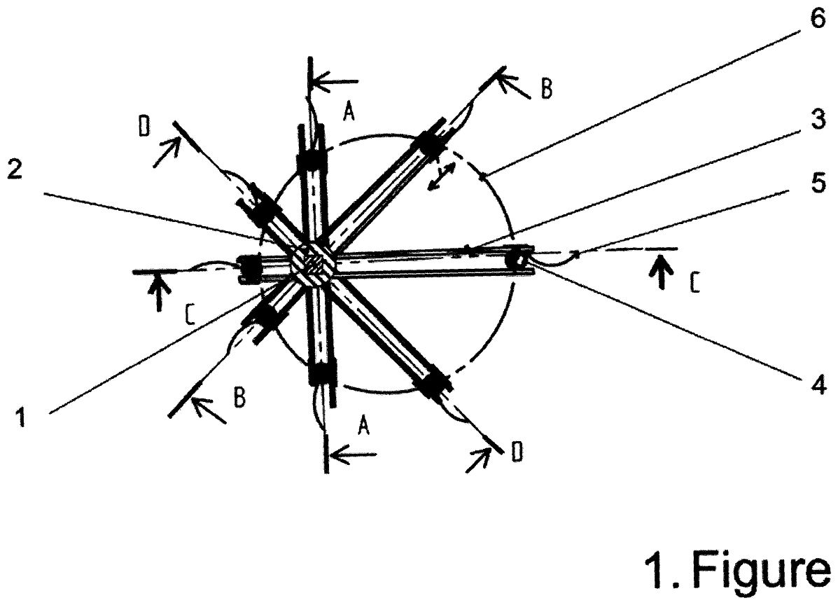

In accordance with the target set the converter of wind or water energy according to the invention is a rotating apparatus provided with blades, which are either magnetically controlled or led mechanically along an open eccentric path of continuously changing radius where one or more sliding blocks are fastened to the driven axle with shapes enabling sliding and their number depends on the number of arms of the blades, secondary sliding blocks are mounted on the arms of the blades where a system is established by their connections, the driven axle and the blades led to a path being eccentric in the relation to the axle. See the FIGS. 1, 2, 3, 4 and 5.

The construction according to the invention has an advantage in comparison to the known technical solutions wherein the energy conversion in relation to the driving axle is performed always in proportion of 1 to 1. Another advantage of the construction according to the invention is that the utilized energy is always loaded onto the longest arms from among the arms of continuously changing lengths during rotation, while the input energy to be converted produces unchanging moment during rotation in the apparatuses known in the state of art. This fact moves extraordinarily in the foreground the small space requirement and highly efficient application of the apparatus according to the invention. It can be applied in natural rivers of small width and high speed, for secondary utilization of out flowing water of water-power stations, in water-falls or for utilization of energy of moving water mass of rivers. It can be also applied for utilization of wind energy both in small or large scales.

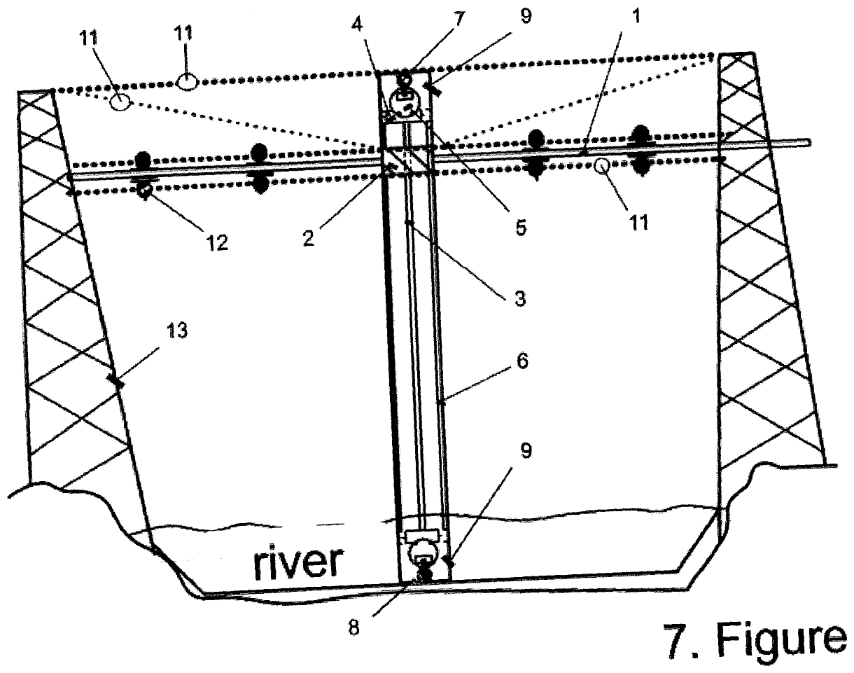

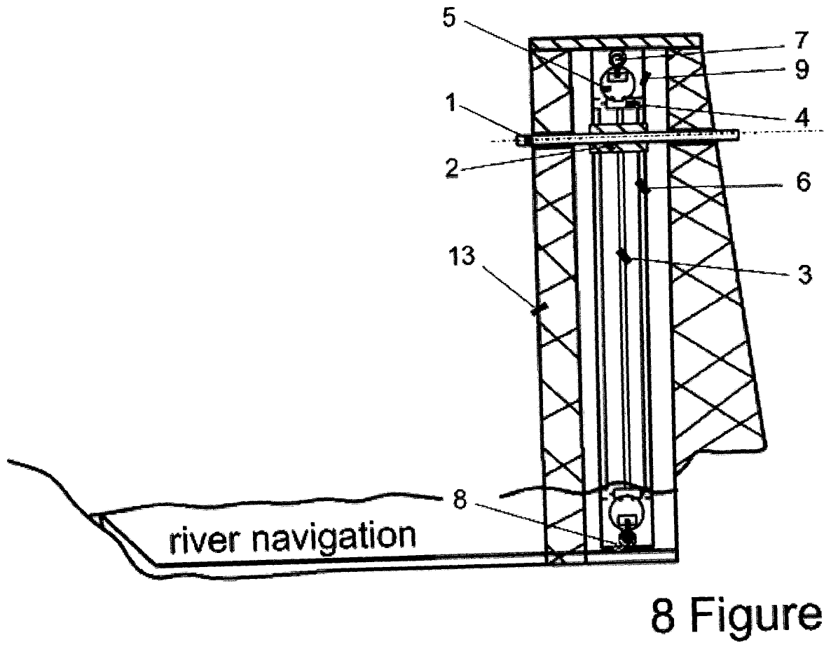

The proportion between the shortest arm of moment and the longest one is determined only by the status according to the state of art. These extraordinary advantages are shown in the FIG. 7, where, applying for utilization of energy of water, the construction according to the invention can be hanged in any part of the cross-section of the river using high-strength static cables bridging the river even up to 500 meters of width. The space requirement of the apparatus can be not greater than 10 meters even in this case. It does not disturb the water-traffic in this way. See the FIG. 8. The height of the apparatus can be realized according to the technical embodiment. It can reach even 50 meters in average. See the FIGS. 7, 8 and 9. In this case the length of the arm of driving moment can be even 40 meters. The oscillation of the driven axle does not influence the safe operation of a possible embodiment of the invention. The deviations from the parallel position of the leading path and the driven axle caused by the continuous oscillation of the axle are compensated by the technical connection provided by the sliding blocks fastened on the driven axle the secondary sliding blocks and the arms of blades connected by sliding connections. See the FIG. 7.

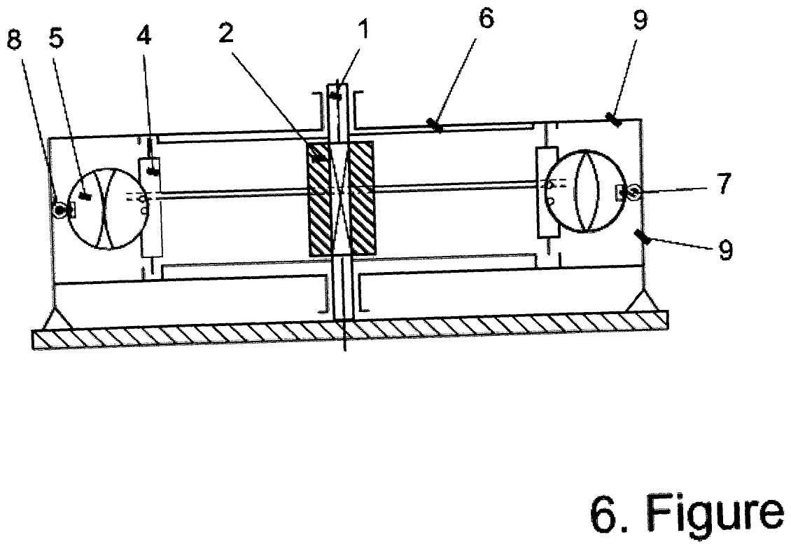

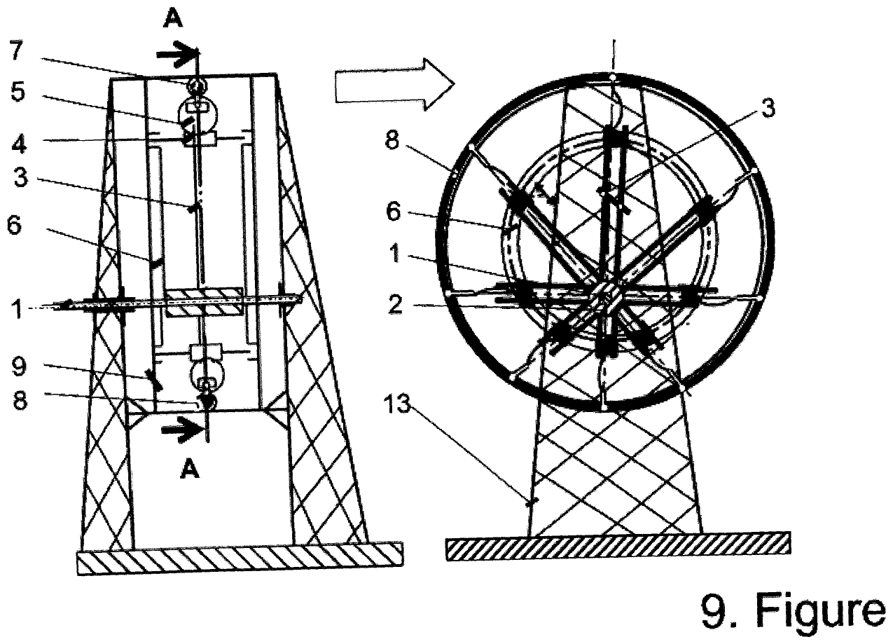

Further advantages are shown in the FIG. 6 which shows other embodiment, where a section of the horizontally arranged embodiment of the FIG. 9 and the intermediate rotation point are shown.

### The Examples of Embodiment of the Invention are Shown Below by Figures

FIG. 1

The most characteristic example of the apparatus for utilizing and converting natural energy according to the invention is shown partially in section. The Figure is divided by further sections A, B, C, C and D.

A sliding block (2) is fastened onto the driven axle (1) and sliding blade arms (3) are mounted in the said block and openings enabling sliding are formed in the secondary sliding blocks (4). Blades (5) are mounted on the secondary sliding blocks (4), and the blades are connected with the leading path (6).

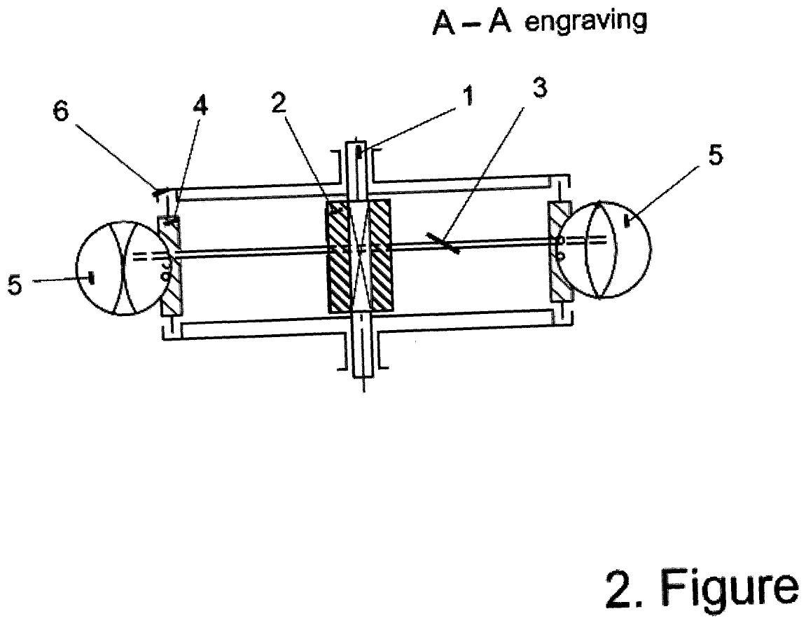

FIG. 2

It shows the section A of the natural wind energy utilizing and converting apparatus according to the invention shown in the FIG. 1, where a sliding block (2) is fastened on the driven axle (1) and sliding blade arms (3) are mounted in the said block They are in connection with secondary sliding blocks (4) provided with openings enabling sliding. Blades (5) are mounted on the secondary sliding blocks (4), and the blades are connected to the leading path (6).

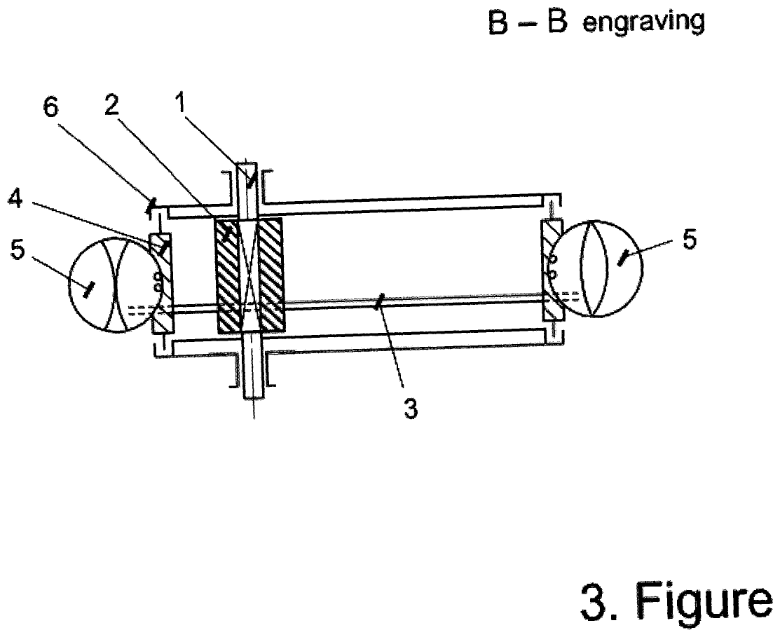

FIG. 3

It shows the section B of the natural wind energy utilizing and converting apparatus according to the invention shown in the FIG. 1, where a sliding block (2) is fastened onto the driven axle (1) and sliding blade arms (3) are mounted in the said block. They are in connection with secondary sliding blocks (4) provided with openings enabling sliding. Blades (5) are mounted on the secondary sliding blocks (4), and the blades are connected to a leading path (6).

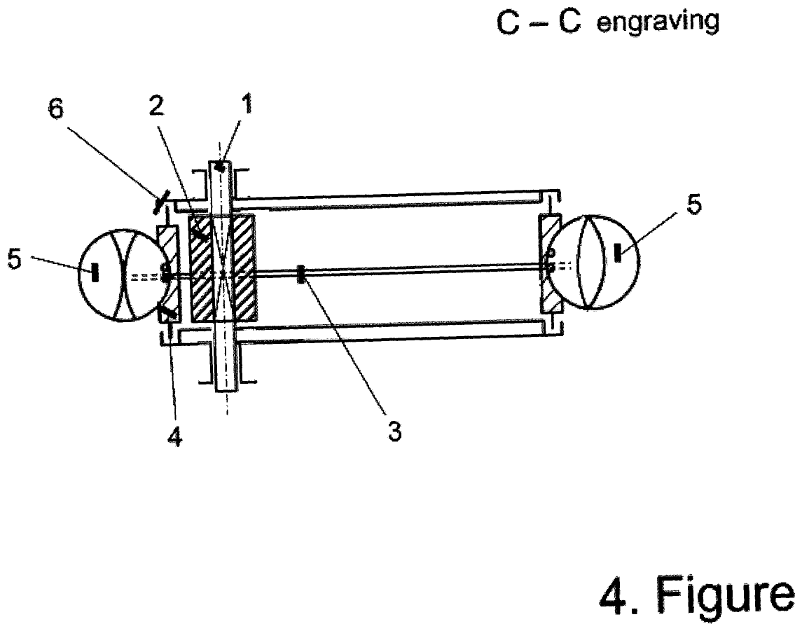

FIG. 4

It shows the section C of the natural wind energy utilizing and converting apparatus according to the invention shown in the FIG. 1 where a sliding block (2) is fastened on the driven axle (1) and sliding blade arms (3) are mounted in the said block. They are in connection with secondary sliding blocks (4) provided with openings enabling sliding. Blades (5) are mounted on the secondary sliding blocks (4), and the blades are connected to the leading path (6).

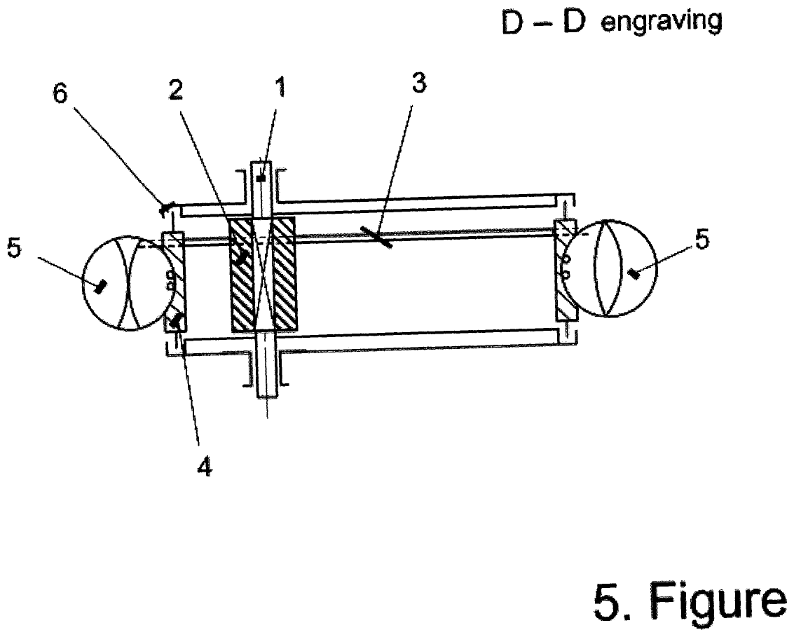

FIG. 5

It shows the section D of the natural wind energy utilizing and converting apparatus according to the invention where a sliding block (2) is fastened on the driven axle (1) and sliding blade arms (3) are mounted in the said block. They are connected to secondary sliding blocks (4) provided with openings enabling sliding. Blades (5) are mounted on the secondary sliding blocks (4) and the blades are connected to the leading path (6).

FIG. 6

It shows the natural wind energy utilizing and converting apparatus according to the invention described in the present description. The embodiment shown in the FIG. 8 in horizontal arrangement, according to that the apparatus is built up provided with a leading path joining and fastening element (9). A sliding block (2) is fastened on the driven axle (1) and sliding blade arms (3) are mounted in the block, and the arms are in sliding connection also with the secondary sliding blocks (4) and blades (5) are mounted on them. The blades (5) are fastened to a leading path joining element (8) of the leading path. They are jointly connected to the leading path (6).

FIG. 7

It shows another embodiment of the natural wind energy utilizing and converting apparatus modified to utilization of water energy in view.

The embodiment is fastened to steel cables (11) bridging between reinforcing supporting columns (13). Supporting elements (12) holding a driven axle (1) are mounted on the said steel cables. A sliding block (2) is fastened on a driven axle (1) with sliding blade arms (3) mounted in the said block. Secondary sliding blocks (4) are provided with openings enabling sliding. Blades (5) are mounted on the secondary sliding blocks (4) and the blades are connected to a leading path (6) through a leading path coupling element (8) connected by a blade path joining and fastening element (9) and a leading path terminal (7).

FIG. 8

It shows the apparatus according to the invention described in the present description built on a river bank in order to keep free the way for water traffic. The apparatus according to the invention is built between reinforcing supporting columns (13). A sliding block (2) is fastened on a driven axle (1) and sliding blade arms (3) are mounted in the block. Openings providing sliding are shaped in the secondary sliding blocks (4). Blades (5) are mounted on the secondary sliding blocks (4) and the said blades are connected to a blade path joining and fastening element (9) connected by a leading path terminal (7) and to a leading path (6) through a leading path coupling element (8).

FIG. 9

It shows another possible embodiment of the natural wind energy utilizing and converting apparatus and a part of its side view is shown in a separate section.

The embodiment is mounted on reinforcing supporting columns (13) where expediently a leading path joining and fastening element (9) is fastened. A sliding block (2) is fastened on a driven axle (1) and sliding blade arms (3) are mounted in the said block. Openings enabling sliding are formed in the secondary sliding blocks (4). Blades (5) are mounted on the secondary sliding blocks (4) and that blades are connected to the blade path joining and fastening element (9) through a leading path terminal (7) and to the leading path (6) through a leading path coupling element (8).

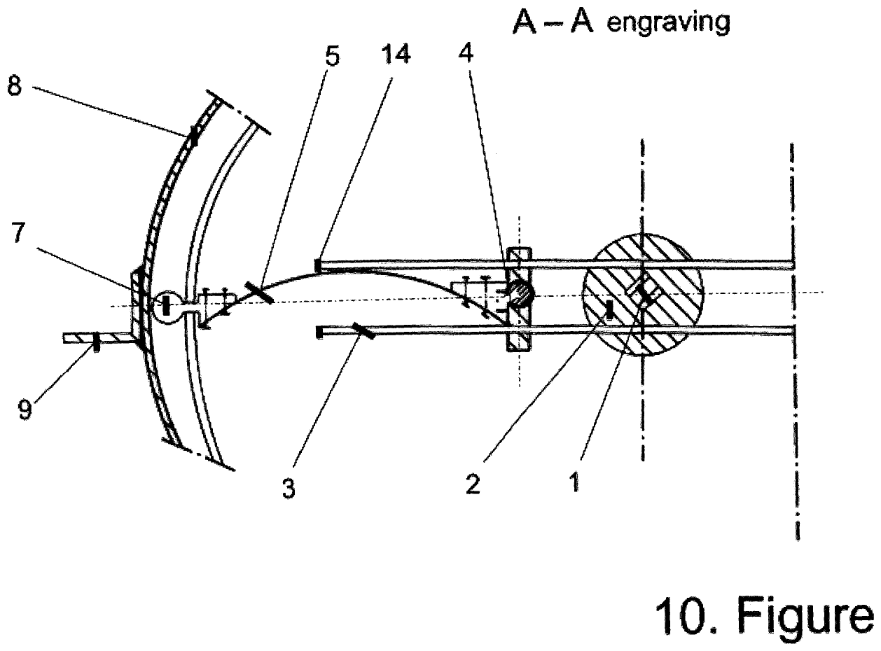

FIG. 10

It shows the section A-A of the FIG. 9. The sliding block (2) is fastened on a driven axle (1). Openings enabling sliding are formed in the sliding block (2) and in blade arms (3). The blade arms end fastener element (14) fitted blade arms (3) are simultaneously in sliding connection with secondary sliding blocks (4). Blades (5) are mounted on them, which are provided with leading path coupling elements (8) and they are connected to a leading path joining and fastening element (9).

### LIST OF DRAWING NUMBERS

1 Driven axle: in the FIGS. 1, 2, 3, 4, 5, 6, 7, 8, 9 and 10.

2 Sliding block or blocks fastened on the driven axle: in the FIGS. 1, 2, 3, 4, 5, 6, 7, 8, 9 and 10

3 Blade arm or blade arms: in the Figures: 1, 2, 3, 4, 5, 6, 7, 8, 9 and 10

4 Secondary sliding block or blocks: in the FIGS. 1, 2, 3, 4, 5, 6, 7, 8, 9 and 10

5 Blade or blades: in the FIGS. 1, 2, 3, 4, 5, 6, 7, 8, 9 and 10

6 Leading path: in the FIGS. 1, 2, 3, 4, 5, 6, 7, 8, 9 and 10

7 Leading path terminal: in the FIGS. 6, 7 and 8

8 Leading path coupling and fastening element: in the FIGS. 7, 8, 9 and 10

9 Leading path fastening and joining element: in the FIGS. 9 and 10

10 Reinforcing steel cable or cables: in the FIG. 7

11 Driven axle supporting or holding element or steel cable holding supporting element: in the FIG. 7

12 Supporting element or elements of the driven axle: in the FIG. 7

13 Reinforcing holding column: in the FIGS. 7 and 8

14 Blade arms end fastener element: in the FIG. 10

1. The subject-matter of the invention is an apparatus for converting wind or water energy; the apparatus is driven by natural energy of wind or water, a rotating energy converter either magnetically or mechanically controlled, wherein blades move along an open eccentric path of continuously changing radius characterized by that one or more fixed sliding blocks (2) are fastened on a driven axle (1) in its construction, where one or more shapes suitable for sliding are provided in those blocks and their number depends on the blade arms (3) of the blades (5), where there are secondary sliding blocks (4) mounted on the blade arms (3) and the blades (5) constituting a power transmission system through their connections and it is realized by the driven axle (1) and the blades (5) led on an eccentric to the axle path (6).

2. The apparatus according to the claim 1, one of the possible embodiments of the invention, characterized by that one or more fixed sliding blocks (2) are fastened on a driven axle (1) which is mounted on reinforcing supporting columns (13), shapes suitable for sliding are in the said sliding blocks of number depending on the number of blade arms (3) and secondary sliding blocks (4) are mounted on the blades (5) and blade arms (3) and a system is established by their connections connecting the driven axle (1) with the blades (5) moving along an eccentric in relation to the axle path (6) and leading path coupling elements (8).

3. The apparatus according to the claim 1, one of the possible embodiments of the invention, characterized by that reinforcing supporting columns (13) are connected by bridging steel cables (11), a driven axle (1) holding or supporting elements (12) are fastened on the cables and a sliding block (2) is fastened on the driven axle (1) the block holds sliding blade arms (3) in itself, there are secondary sliding blocks (4) mounted to blades (5) and they establish a system through their connections between the driven axle (1) and the blades (5) led along a leading path (6) eccentric in relation to the driven axle (1) by means of leading path coupling elements (8).

4. The apparatus according to the claim 1 characterized by that a blade leading path element (9) is included in the construction of another embodiment, a sliding block (2) is fastened on a driven axle (1) the said block holds sliding blade arms (3) in itself, the blade arms are in sliding connection also with secondary sliding blocks (4), blades (5) are mounted on them, the blades (5) are connected to a leading path coupling element (8) and they are together connected to the leading path (6).
